(19) United States
(12) Patent Application Publication
(10) Pub. No.: US 2019/0049781 A1
(43) Pub. Date: Feb. 14, 2019

(54) HIGH EFFICIENCY QUANTUM DOT LIQUID CRYSTAL DISPLAYS

(71) Applicant: INTEL CORPORATION, Santa Clara, CA (US)

(72) Inventors: JUN JIANG, Portland, OR (US); ZHIMING ZHUANG, Sammamish, WA (US); KHALED AHMED, Anaheim, CA (US)

(73) Assignee: INTEL CORPORATION, Santa Clara, CA (US)

(21) Appl. No.: 16/153,513

(22) Filed: Oct. 5, 2018

(51) Int. Cl. G02F 1/1335; G02F 1/017

(52) U.S. Cl. CPC G02F 1/133514; G02F 1/133617; G02F 2001/01791; G02F 1/133602; G02F 1/017; G02F 1/133528

(57) ABSTRACT

The present disclosure is directed to quantum dot LCD display systems and methods that use a digital optics polarizer to beneficially and advantageously provide enhanced performance and substantially lower power draw. The digital optics polarizer is disposed as a metasurface between the LCD layer and the quantum dot layer within the LCD display device. The digital optics polarizer is formed using a dielectric material, such as TiO₂, that does not cause reflectivity and ohmic loss issues typically encountered with wire grid polarizers. The digital optics polarizer may be patterned, deposited, or otherwise disposed across all or a portion of the LCD layer, the quantum dot layer, or may be “sandwiched” between and proximate the LCD layer and the quantum dot layer. The elimination of ohmic losses in the digital optics polarizer significantly improves the energy efficiency of the LCD display.

### TECHNICAL FIELD

The present disclosure relates to liquid crystal display, specifically quantum dot liquid crystal displays.

### BACKGROUND

Quantum dot display devices employ semiconductor nanocrystals that emit pure monochromatic light. Quantum dots range in diameter from 2 nanometers (nm) to 6 nm and are highly efficient at absorbing and emitting electromagnetic energy. Each quantum dot emits electromagnetic radiation at a specific wavelength dependent upon the diameter of the dot. For example, a quantum dot having a diameter of about 2 nm emits electromagnetic energy in the visible blue spectrum while quantum dots having a diameter of about 6-7 nm emits electromagnetic energy in the visible red spectrum. The ability of quantum dots to produce extremely narrow wavelength bands permits a more clear distinction between the red, green, and blue colors in a display device.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic diagram of an illustrative system that includes a digital optics polarizer disposed between a liquid crystal display (LCD) layer and quantum dot layer, in accordance with at least one embodiment described herein;

FIG. 2 is a partial cross-section of an illustrative quantum dot LCD display system that incorporates a digital optics polarizer disposed between the LCD layer and the quantum dot layer, in accordance with at least one embodiment described herein;

FIG. 3 is a perspective view of a portion of an illustrative system that includes a digital optics polarizer that includes a plurality of dielectric nanoparticles carries on a dielectric spacer and in which the digital optics polarizer is disposed proximate an LCD layer, in accordance with at least one embodiment described herein;

FIG. 4 is a partial cross-section of an illustrative quantum dot LCD display system that incorporates a digital optics polarizer and a pixelated quantum dot layer that includes a thin color filter layer disposed proximate the quantum dot layer, in accordance with at least one embodiment described herein;

FIG. 5 is a partial cross-section of an illustrative quantum dot LCD display system that incorporates a digital optics polarizer and a non-pixelated quantum dot layer that includes a thin color filter layer disposed proximate the non-pixelated quantum dot layer, in accordance with at least one embodiment described herein;

FIG. 6 is a schematic diagram of an illustrative electronic, processor-based, device that includes processor circuitry and a graphics processing unit coupled to an LCD display device, in accordance with at least one embodiment described herein;

FIG. 7 is a high-level flow diagram of an illustrative method of providing a display output using a quantum dot LCD display device that includes a digital optics polarizer disposed between the LCD layer and the quantum dot layer, in accordance with at least one embodiment described herein; and

FIG. 8 is a high-level flow diagram of an illustrative method of providing a display output using a quantum dot LCD display device that includes a digital optics polarizer disposed between an LCD layer and a quantum dot layer and which includes a thin color filter to improve the contrast and clarity of the display image, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

Quantum dots provide excellent energy down-conversion capable of converting incident electromagnetic energy in the blue and/or ultraviolet spectrum to an output having narrow band emissions in the visible red, green, and blue electromagnetic spectrum. One quantum dot display technology employs pixelated quantum dots (QD-CF) to replace the color filters found in conventional displays. A typical liquid crystal display (LCD) includes a top polarizer disposed above the color filter layer. In an LCD display using pixelated quantum dots, the top polarizer may be positioned between the color filter and liquid crystal layers.

Some LCDs may use wire grid polarizers in which a plurality of metal ribs formed on a substrate. Such electrically conductive, optically reflective polarizers have numerous drawbacks. For example, in bright ambient light conditions, reflections from a wire grid polarizer are undesirable, washing out the display and reducing contrast. In addition, with wire grid polarizers an ohmic loss occurs due to the interaction between the electromagnetic emission and the metal forming the wire grid polarizer. Thus, wire grid polarizers are both inefficient and plagued by poor performance in bright ambient conditions.

Optical films may be used to improve the spatial distribution of the electromagnetic energy emitted by the backlight. A quantum dot enhancement film (QDEF) may provide at least a portion of the optical film to purify the backlight spectrum and improve display color performance. However, in such displays up to ⅔ of the electromagnetic energy emitted by the backlight is lost and only about ⅓ of the electromagnetic energy emitted by the backlight is available to provide the visible image on the display.

The systems and methods disclosed herein provide a quantum dot LCD display that is both energy efficient and provides improved performance in bright ambient conditions. The systems and methods disclosed herein eliminate the use of a wire grid polarizer in the LCD display and instead dispose a digital optics polarizer in the form of a metasurface sandwiched between a quantum dot color converter (QD-CC) and the liquid crystal (LC) layer. The metasurface is formed using one or more dielectric materials and is less than a few hundred nanometers in thickness. Since the metasurface functions as an absorptive rather than reflective polarizer, there are no reflective issues when the display is used in bright ambient conditions. The use of a very thin metasurface provides greater transmissivity than a wire grid polarizer. In addition, the metasurface digital optics polarizer does not experience the ohmic losses of a wire grid polarizer, significant energy savings may be realized—greatly improving the life of battery powered devices using quantum dot LCD displays in accordance with those described herein. Thus, the systems and methods described herein provide an energy efficient LCD display device that offers significant power savings over LCD displays using a wire grid polarizer. The reduction in power consumption attributable to an LCD display using a digital optics polarizer advantageously improves the working life of battery powered devices such as laptops, smartphones, and tablets.

The systems and methods described herein improve the efficiency and performance of LCDs by reducing the thickness of the color filter or by removing the color filter in its entirety. The systems and methods described herein move the quantum dot layer from the backlight to replace the conventional color filter. In addition, a highly collimated backlight design may be used and the pixelated quantum dots may convert the electromagnetic energy produced by a blue or UV backlight into red, green, and blue electromagnetic energy in the visible spectrum. The systems and methods described herein make use of a digital optics polarizer that is deposited as a metasurface between the liquid crystal and quantum dot layers. Using this physical configuration, the energy efficiency of quantum dot based LCDs may be improved as much as three-fold over conventional quantum dot LCDs. The systems and methods described herein locate the digital optics polarizer inside the liquid crystal cell.

A liquid crystal display (LCD) is provided. The LCD may include: a quantum dot color converter; a liquid crystal layer; and a metasurface layer that provides a digital optics polarizer disposed between the quantum dot color converter and the liquid crystal layer.

A method of generating an image using a liquid crystal display (LCD) is provided. The method may include: generating an electromagnetic output; applying a current to a liquid crystal layer; causing at least a portion of the generated electromagnetic output to pass through a first polarizer to provide an electromagnetic output having a first polarization; causing at least a portion of the electromagnetic output having a first polarization to pass through the liquid crystal layer; causing at least a portion of the electromagnetic output exiting the liquid crystal layer to pass through a digital optics polarizer that includes metasurface layer to provide an electromagnetic output having a second polarization; and causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

A system for generating an image using a liquid crystal display (LCD) is provided. The system may include: means for generating an electromagnetic output; means for applying a current to a liquid crystal layer; means for causing at least a portion of the generated electromagnetic output to pass through a first polarizer to provide an electromagnetic output having a first polarization; means for causing at least a portion of the electromagnetic output having a first polarization to pass through the liquid crystal layer; means for causing at least a portion of the electromagnetic output exiting the liquid crystal layer to pass through a digital optics polarizer that includes metasurface layer to provide an electromagnetic output having a second polarization; and means for causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

An electronic device is provided. The electronic device may include: processor circuitry; output interface circuitry; and a liquid crystal display coupled to the output interface circuitry, the liquid crystal display including: a quantum dot color converter; a liquid crystal layer; and a metasurface layer that provides a digital optics polarizer disposed between the quantum dot color converter and the liquid crystal layer.

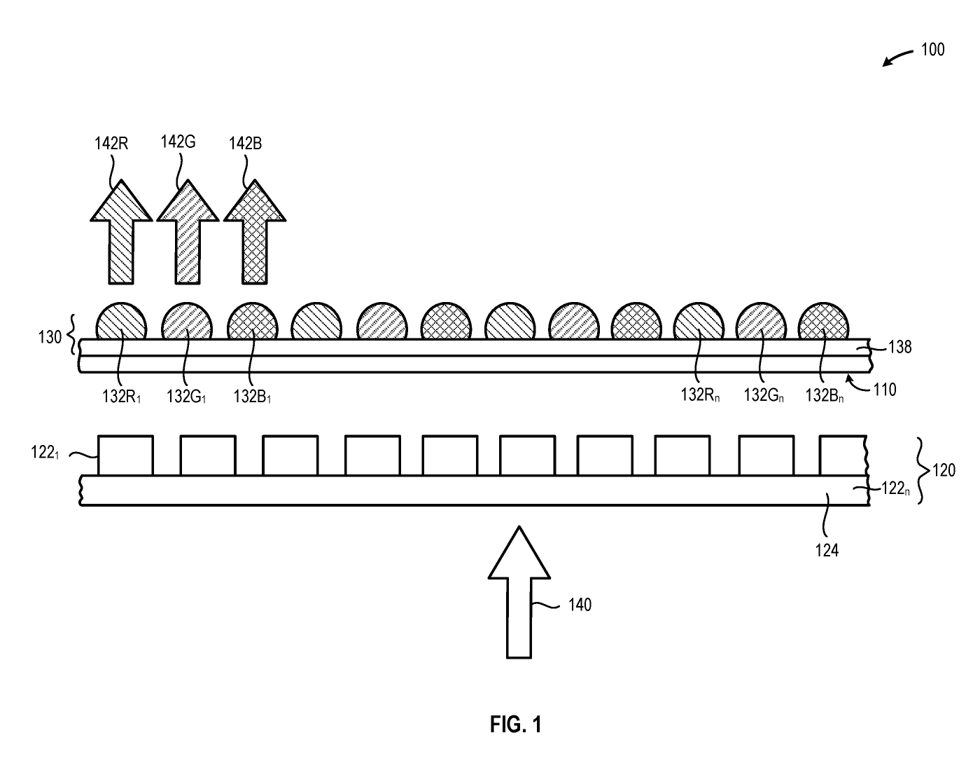

FIG. 1 is a schematic diagram of an illustrative system 100 that includes a digital optics polarizer 110 disposed between a liquid crystal display (LCD) layer 120 and quantum dot layer 130, in accordance with at least one embodiment described herein. The digital optics polarizer 110 includes one or more dielectric materials disposed as a metasurface across all or a portion of at least one of the LCD layer 120 and/or the quantum dot layer 130. The LCD layer 120 includes a plurality of liquid crystals 1221-122n (collectively, “liquid crystals 122”). In embodiments, the liquid crystals 122 may be disposed uniformly or non-uniformly across a substrate 124. The quantum dot layer 130 includes a plurality of red quantum dots 132R₁-132Rₙ (collectively, “red quantum dots 132R”) and a plurality of green quantum dots 132G₁-132Gₙ (collectively, “green quantum dots 132G”). In embodiments such as that depicted in FIG. 1, the quantum dot layer may also include a plurality of blue quantum dots 132B₁-132Bₙ (collectively, “blue quantum dots 132B”). The quantum dots included in the quantum dot layer 130 may be collectively referred to as “quantum dots 132.”

In operation, electromagnetic energy 140 that may include electromagnetic energy at one or more wavelengths from ultraviolet (e.g., 10 nm to 390 nm) through the visible spectrum (e.g. 390 nm to 700 nm). Current applied to each of the liquid crystals 122 in the LCD layer 120 selectively alters the passage of electromagnetic energy 140 through the respective liquid crystal. The electromagnetic energy exits at least a portion of the LCD layer 120 and falls incident on the digital optics polarizer 110. The digital optics polarizer 110 passes electromagnetic energy having a defined polarization (e.g., electromagnetic energy having a polarization normal to the digital optics polarizer 110). The electromagnetic energy exits the digital optics polarizer 110 and falls incident on the quantum dots 132R, 132G, 132B forming the quantum dot layer 130. The red quantum dots 132R convert at least a portion of the incident electromagnetic energy to a visible output in a narrow band of the visible red spectrum 142. The green quantum dots 132G convert at least a portion of the incident electromagnetic energy to a visible output in a narrow band of the visible green spectrum 144. Where used, the blue quantum dots 132B convert at least a portion of the incident electromagnetic energy to a visible output in a narrow band of the visible blue spectrum 146.

The digital optics polarizer 110 may include any number and/or combination of dielectric materials deposited as a metasurface on at least one of the LCD layer 120 or the quantum dot layer 130. The digital optics polarizer 110 may include a plurality of sub-wavelength resonators having a sub-wavelength thickness (compared to the wavelength of the electromagnetic energy 140) forming an array across all or a portion of the LCD layer 120 or the quantum dot layer 130. The digital optics polarizer 110 may include a plurality of relatively high refractive index members formed using one or more dielectric materials surrounded by a relatively low refractive index medium. The digital optics polarizer 110 may be disposed uniformly or non-uniformly across at least one of the LCD layer 120 or the quantum dot layer 130. The digital optics polarizer may be deposited as a continuous or discontinuous layer across all or a portion of at least one of the LCD layer 120 or the quantum dot layer 130. In embodiments, physical properties, such as thickness, crystalline structure, materials, surface finish, and similar, may be uniform or non-uniform throughout the digital optics polarizer 110. Such differences in digital optics polarizer 110 physical properties may permit the selective output of electromagnetic energy having different polarizations across the digital optics polarizer 110.

In embodiments, the digital optics polarizer 110 may be patterned on all or a portion of at least one of: the LCD layer 120 or the quantum dot layer 130. In at least one embodiment, the digital optics polarizer 110 may include titanium dioxide (TiO₂) having a thickness of: about 500 nanometers (nm) or less; about 400 nm or less; about 300 nm or less; about 200 nm or less; about 100nm or less; about 50 nm or less. The digital optics polarizer 110 may be formed, deposited, patterned, or otherwise disposed across all or a portion of one or more of the LCD layer 120 or the quantum dot layer 130 using any currently available or future developed material deposition process. Example material deposition processes include but are not limited to: atomic layer deposition (ALD); physical vapor deposition (PVD); chemical vapor deposition (CVD); electrochemical deposition (ECD); molecular beam epitaxy (MBE); photolithography; printing; or combinations thereof.

The LCD layer 120 may include any currently available or future developed active or passive matrix liquid crystal display. The LCD layer 120 may include any number of liquid crystals 122 arranged in an n×m matrix having a “n” columns of liquid crystals 122 and “m” rows of liquid crystals. In embodiments, the LCD layer 120 may include: 1,000 or more rows of liquid crystals 122; 2,000 or more rows of liquid crystals 122; 5,000 or more rows of liquid crystals 122; 10,000 or more rows of liquid crystals 122; 15,000 or more rows of liquid crystals 122; or 20,000 or more rows of liquid crystals 122. In embodiments, the LCD layer 120 may include: 1,000 or more columns of liquid crystals 122; 2,000 or more columns of liquid crystals 122; 5,000 or more columns of liquid crystals 122; 10,000 or more columns of liquid crystals 122; 15,000 or more columns of liquid crystals 122; or 20,000 or more columns of liquid crystals 122.

The LCD layer 120 receives incident electromagnetic energy 140 having a defined polarization. Depending on the current applied to the individual liquid crystals 122, each liquid crystal 122 either blocks the transmission of the incident electromagnetic energy 140 or passes at least a portion of the incident electromagnetic energy 140. The incident electromagnetic energy 140 may include electromagnetic energy in the visible electromagnetic spectrum (390 nm to 700 nm) and/or the ultraviolet spectrum (10 nm to 390 nm).

The quantum dot layer 130 may include any number and/or combination of currently available or future developed quantum dots capable of absorbing an electromagnetic energy input and providing a monochromatic output in the visible electromagnetic spectrum. The quantum dots 132R, 132G, and 132B disposed across the quantum dot layer 130. In some embodiments, the quantum dot layer 130 may include red quantum dots 132R and green quantum dots 132G. In other embodiments, the quantum dot layer may include red quantum dots 132R, green quantum dots 132G, and blue quantum dots 132B. The quantum dots 132R, 132G, and 132B may be evenly distributed or unevenly distributed across the surface of the quantum dot layer 130. In embodiments, the red, green, and blue quantum dots may be distributed across all or a portion of the quantum dot layer 130 in equal numbers (i.e., the same number of red, green, and blue quantum dots may be included in the quantum dot layer 130). In other embodiments, the red, green, and blue quantum dots may be distributed across all or a portion of the quantum dot layer 130 in unequal in numbers (e.g., the number of green quantum dots may be double the number of red quantum dots). In embodiments, the quantum dots 132R, 132G, and 132B may be disposed in a regular pattern across all or a portion of the surface of the quantum dot layer 130. In other embodiments, the quantum dots 132, 132G, and 132B may be disposed randomly or pseudo-randomly across all or a portion of the surface of the quantum dot layer 130. Although red, green, and blue quantum dots are discussed, those of ordinary skill in the relevant arts will readily appreciate that quantum dots of any color may be similarly disposed in the quantum dot layer 130.

In embodiments, the quantum dots 132 may any currently available or future developed material and/or combination of materials capable of receiving an electromagnetic energy input at a first wavelength and producing an electromagnetic energy output at a second wavelength, at least a portion of which falls into the visible electromagnetic spectrum (390 nm to 700 nm). Example quantum dot materials include but are not limited to: cadmium selenide; cadmium sulfide; indium arsenide; or indium phosphide. In embodiments, the composition of the quantum dots 132 may be uniform across at least a portion of the surface of the quantum dot layer 130. In other embodiments, the quantum dots 132 disposed across at least a portion of the surface of the quantum dot layer 130 may have two or more different compositions. The wavelength of the electromagnetic emission from each quantum dot 132 depends, at least in part, on the diameter of the respective quantum dot 132. For example, a quantum dot 132 having a diameter of about 2 nm may fluoresce in the visible blue spectrum at about 500 nm; a quantum dot 132 having a diameter of about 3 nm may fluoresce in the visible green spectrum at about 575 nm; and a quantum dot having a diameter of about 6 nm may fluoresce in the visible red spectrum at about 640 nm.

In embodiments, the quantum dots 132 forming the quantum dot layer 130 emit visible electromagnetic energy in a spectral band determined by the composition and/or one or more physical properties (e.g., the diameter) of the respective quantum dot 132. In embodiments, the red quantum dots 132R emit electromagnetic energy 142R in the visible red spectrum; the green quantum dots 132G emit electromagnetic energy 142G in the visible green spectrum; and (where present) the blue quantum dots 132B emit electromagnetic energy 142B in the visible blue spectrum.

The incident electromagnetic energy 140 may include electromagnetic energy at one or more wavelengths provided or produced by any currently available or future developed electromagnetic energy source. In embodiments, the incident electromagnetic energy 140 may include electromagnetic energy in all or a portion of the visible electromagnetic spectrum (390 nm to 700 nm). For example, the incident electromagnetic energy may include electromagnetic energy in the visible blue electromagnetic spectrum (400 nm to 500 nm) produced using one or more blue light emitting diodes. In embodiments, the incident electromagnetic energy 140 may include electromagnetic energy in all or a portion of the ultraviolet electromagnetic spectrum (200 nm to 400 nm). For example, using an ultraviolet LED having an output electromagnetic spectrum of from about 360 nm to about 400 nm.

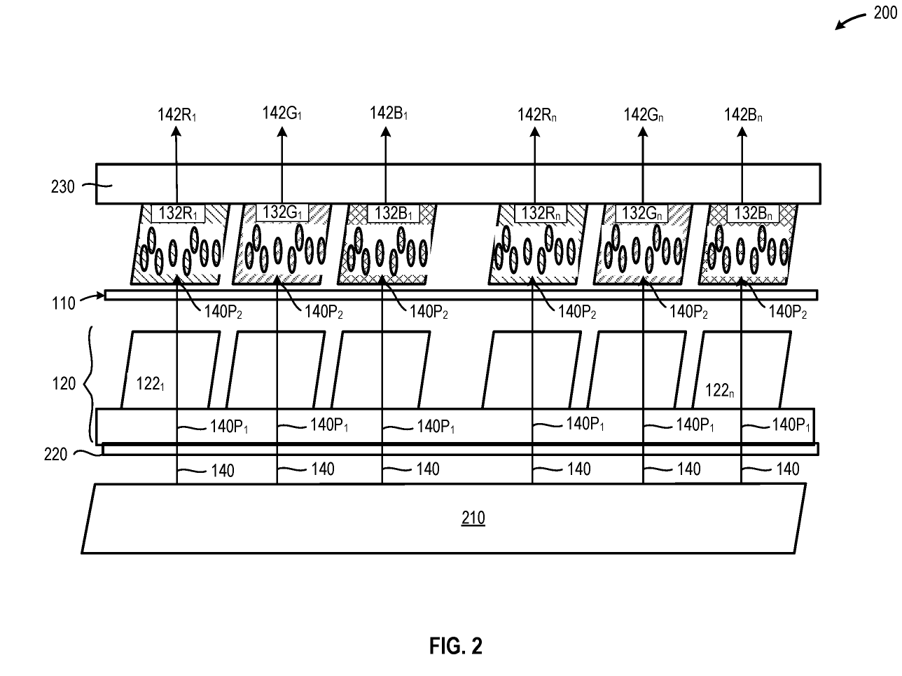

FIG. 2 is a partial cross-section of an illustrative quantum dot LCD display system 200 that incorporates a digital optics polarizer 110 disposed between the LCD layer 120 and the quantum dot layer 130, in accordance with at least one embodiment described herein. As depicted in FIG. 2, a backlight 210 emits electromagnetic energy 140 that passes through a rear polarizer 220. The polarized electromagnetic energy 140P₁ exits the rear polarizer 220 and enters the LCD layer 120. At least a portion of the polarized electromagnetic energy 140P₁ may pass through the liquid crystals 122 forming the LCD layer 120. The polarized electromagnetic energy 140P₁ passes through the digital optics polarizer 110 and exits as polarized electromagnetic energy 140P₂. The polarized electromagnetic energy 140P₂ may have a polarization that is generally perpendicular to the quantum dot layer 130. In embodiments, the polarized electromagnetic energy 140P₂ enters the quantum dots 132 forming the quantum dot layer 130, causing the quantum dots to emit visible electromagnetic energy 142R, 142G, and 142B. The visible electromagnetic energy 142 passes through a color filter glass 230 and exits the LCD panel 200.

The backlight 210 may include any currently available or future developed source capable of emitting electromagnetic energy 140 within a defined spectral band. In some embodiments, the backlight 210 may include one or more sources capable of emitting electromagnetic energy in at least the blue spectral band that extends from about 400 nm to about 500 nm. In other embodiments, the backlight 210 may include one or more sources capable of emitting electromagnetic energy in at least the ultraviolet spectral band that extends from about 200 nm to about 400 nm. In at least some embodiments, the backlight 210 may include a plurality of light emitting diodes (LEDs) capable of emitting electromagnetic energy in the ultraviolet and/or visible blue spectral bands.

The rear polarizer 220 may include one or more devices and/or combinations of devices capable of passing electromagnetic energy having at least a first polarization and preventing the passage of electromagnetic energy having at least a second polarization. The rear polarizer 220 may include but is not limited to: a reflective polarizer, a transmissive polarizer, or a transreflective polarizer. In some embodiments, the rear polarizer 220 may pass at least a portion of the electromagnetic energy 140 having a polarization that is perpendicular to the surface of the rear polarizer 220 and may block the passage of at least a portion of the electromagnetic energy having a polarization that is parallel to the surface of the rear polarizer 220. The polarized electromagnetic energy 140P₁ exits from the rear polarizer 220. The LCD layer 120 selectively permits the passage of none, some, or all of the polarized electromagnetic energy 140P₁ dependent upon the voltage applied to the liquid crystals 122.

The polarized electromagnetic energy 140P₁ that passes through the LCD layer 120 falls incident upon the digital optics polarizer 110. The digital optics polarizer 110 selectively permits at least a portion of the polarized electromagnetic energy 140P₁ to pass through into the quantum dot layer 130. In embodiments, the digital optics polarizer 110 permits the passage of incident polarized electromagnetic energy 140P₁ that is normal to the surface of the digital optics polarizer 110. Although shown proximate the quantum dot layer 130 in FIG. 2, in some embodiments, the digital optics polarizer 110 may be positioned proximate all or a portion of the LCD layer 120. In other embodiments, the digital optics polarizer 110 may be positioned such that the upper surface of the digital optics polarizer 110 is proximate all or a portion of the quantum dot layer 130 and the lower surface of the digital optics polarizer 110 is proximate all or a portion of the LCD layer 120. Polarized electromagnetic energy 140P₂ exits from the digital optics polarizer 110 and enters the quantum dot layer 130. The rear polarizer 220 and the digital optics polarizer 110 work with the LCD layer 120 to provide light switches for each pixel/liquid crystal 122.

Within the quantum dot layer 130, the quantum dots 132R, 132G, and 132B absorb the polarized electromagnetic energy 140P₂ and emit visible electromagnetic energy within a defined spectral band that includes: visible red light (e.g., wavelengths from about 620 nm to about 790 nm) from the red quantum dots 132R; visible green light (e.g., wavelengths from about 490 nm to about 580 nm) from the green quantum dots 132G; and visible blue light (e.g., wavelengths from about 390 nm to about 490 nm) from the blue quantum dots 132B. In embodiments, one or more quantum dots 132 may be aligned with a respective liquid crystal 122 and the opacity of the liquid crystal 122 altered, controlled, or adjusted to provide a variable electromagnetic output from the one or more quantum dots 132. As depicted in FIG. 2, in some embodiments, the quantum dots 132 may be positioned, placed, distributed, or disposed to form a quantum dot layer 130 having a regular or pattern or matrix. The visible electromagnetic energy 142R, 142G, and 142B emitted by the quantum dots 132R, 132G, and 132B, respectively, pass through the color filter glass 230 disposed proximate the quantum dot layer 130.

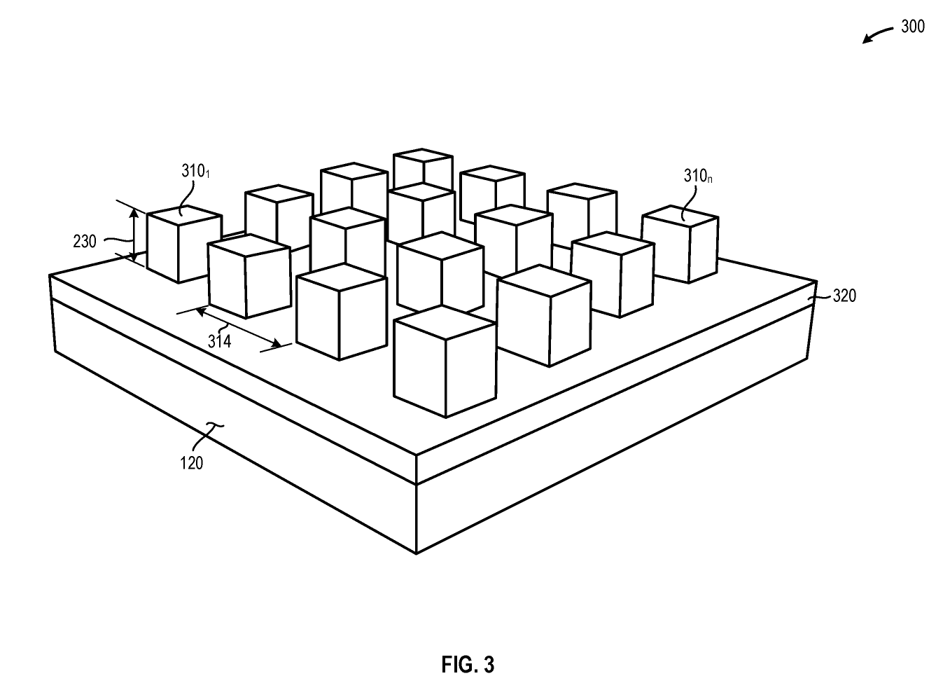

FIG. 3 is a perspective view of a portion of an illustrative system 300 that includes a digital optics polarizer 110 that includes a plurality of dielectric nanoparticles 310₁-310ₙ (collectively, “dielectric nanoparticles 310”) carries on a dielectric spacer 320 and in which the digital optics polarizer 110 is disposed proximate an LCD layer 120, in accordance with at least one embodiment described herein. As depicted in FIG. 3, the digital optics polarizer 110 may include a plurality of dielectric nanoparticles 310 disposed in a regular or irregular pattern across a dielectric carrier 320. The digital optics polarizer 110, including the dielectric nanoparticles 310 and the dielectric film 320, may be disposed on, about, or across all or a portion of the LCD layer 120.

As depicted in FIG. 3, the digital optics polarizer 110 may include a plurality of dielectric nanoparticles having a height 312 from the surface dielectric carrier 320 of: about 500 nm or less; about 300 nm or less; about 100 nm or less; or about 50 nm or less. The individual dielectric nanoparticles 310 may have any physical configuration, including, but not limited to: cubic, cylindrical, pyramidal, hemispherical, triangular prismatic, rectangular prismatic, and conical. The individual dielectric nanoparticles 310 may be disposed in a regular pattern (as depicted in FIG. 3) or in an irregular pattern (not shown). In some embodiments, the dielectric nanoparticles 310 may be disposed in a square pattern having a pitch of from about 50 nm to about 150 nm. In some embodiments, the dielectric nanoparticles 310 may have an aspect ratio (height:pitch) of about 3:1 or less; about 4:1 or less; about 5:1 or less; about 10:1 or less. The dielectric nanoparticles 310 may include one or more dielectric materials. In embodiments, the dielectric nanoparticles 310 may include titanium dioxide (TiO₂−dielectric constant=85 @1 MHz).

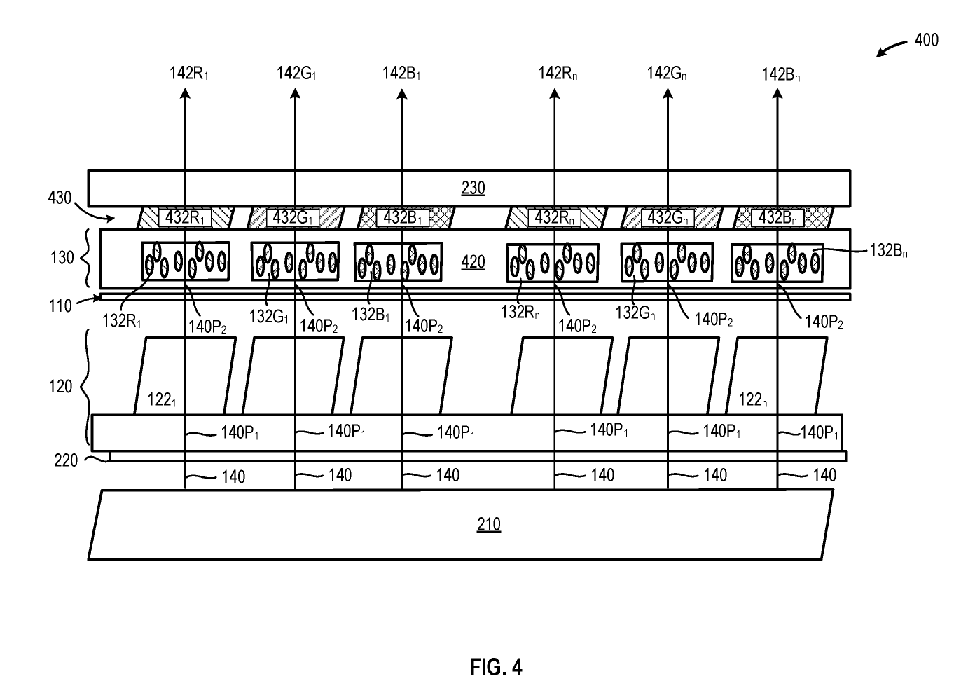

FIG. 4 is a partial cross-section of an illustrative quantum dot LCD display system 400 that incorporates a digital optics polarizer 110 and a pixelated quantum dot layer 130 that includes a thin color filter layer 430 disposed proximate the quantum dot layer 130, in accordance with at least one embodiment described herein. As depicted in FIG. 4, the pixelated quantum dot layer 130 may include quantum dots 132R, 132G, and 132B disposed partially or completely within a carrier film 420. A color filter layer 430 may be disposed between the pixelated quantum dot layer 130 and the cover layer 230. In embodiments, the presence of the color filter layer 430 beneficially improves the performance of the display 400 in bright ambient conditions, improving the contrast ratio of the LCD display 400. The color filter layer 430 includes red color filters 432R₁-432Rₙ (collectively, “red color filters 432R”) disposed proximate at least a portion of the red quantum dots 132R; green color filters 432G₁-432Gₙ (collectively, “green color filters 432G”) disposed proximate at least a portion of the green quantum dots 132G; and blue color filters 432B₁-432Bₙ (collectively, “blue color filters 432B”) disposed proximate at least a portion of the blue quantum dots 132B.

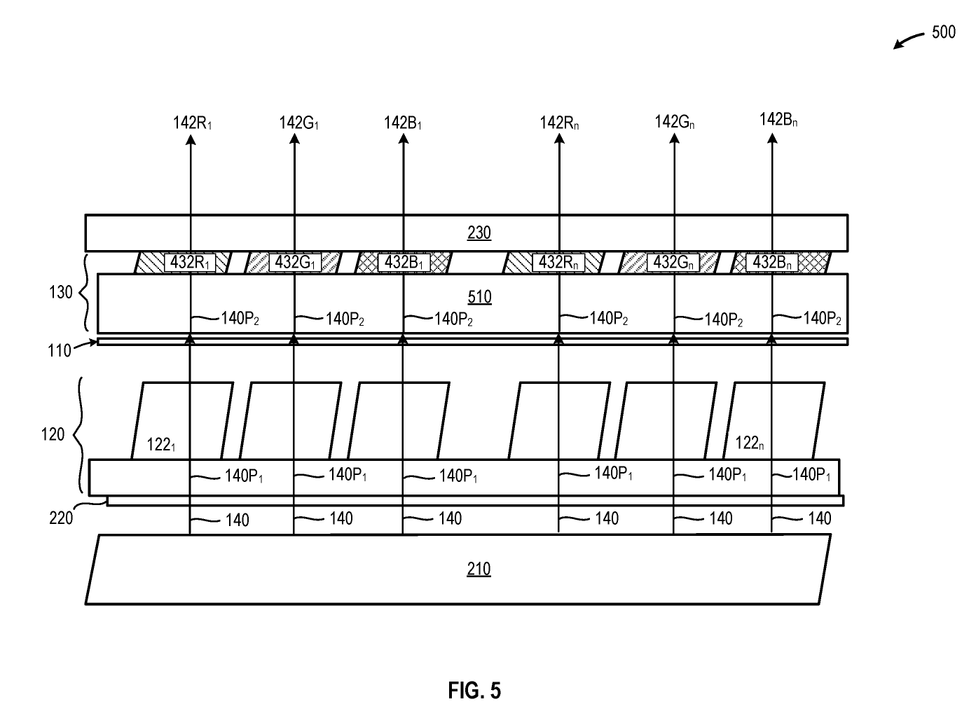

FIG. 5 is a partial cross-section of an illustrative quantum dot LCD display system 500 that incorporates a digital optics polarizer 110 and a non-pixelated quantum dot layer 510 that includes a thin color filter layer 430 disposed proximate the non-pixelated quantum dot layer 510, in accordance with at least one embodiment described herein. As depicted in FIG. 5, in some embodiments, the LCD display system 500 may include red quantum dots, green quantum dots, and blue quantum dots are distributed randomly or pseudo-randomly distributed throughout all or a portion of the non-pixelated quantum dot layer 510. In such embodiments, the quantum dot layer 130 may provide an approximate visible white electromagnetic emission. The white light generated by the non-pixelated quantum dot layer 510 pass through the red color filters 432R, the green color filters 432G, and the blue color filters 432B to provide the display output.

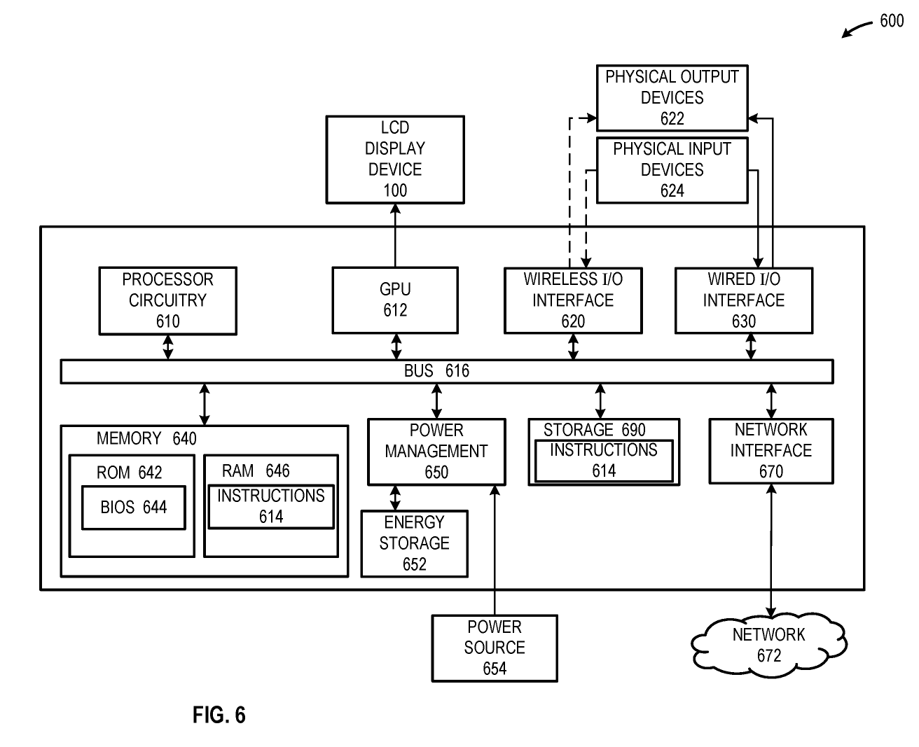

FIG. 6 is a schematic diagram of an illustrative electronic, processor-based, device 600 that includes processor circuitry 610 and a graphics processing unit 612 coupled to an LCD display device 100, in accordance with at least one embodiment described herein. The processor-based device 600 may additionally include one or more of the following: a wireless input/output (I/O) interface 620, a wired I/O interface 630, system memory 640, power management circuitry 650, a network interface 670, and a non-transitory storage device 690. The following discussion provides a brief, general description of the components forming the illustrative processor-based device 600. Example, non-limiting processor-based devices 600 may include, but are not limited to: smartphones, wearable computers, portable computing devices, handheld computing devices, desktop computing devices, blade server devices, workstations, and similar.

The processor circuitry 610 may include any number, type, or combination of currently available or future developed devices capable of executing machine-readable instruction sets. The processor circuitry 610 may include but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 6 are of conventional design. Consequently, such blocks need not be described in further detail herein, as they will be understood by those skilled in the relevant art. A bus 616 interconnects at least some of the components of the processor-based device 600 and may employ any currently available or future developed serial or parallel bus structures or architectures.

In embodiments, the processor-based device 600 includes graphics processor circuitry 612 capable of executing machine-readable instruction sets 614 and generating an output signal capable of providing a display output to the LCD display device 100. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. The processor circuitry 610 may include any number of hardwired or configurable circuits, some or all of which may include programmable and/or configurable combinations of electronic components, semiconductor devices, and/or logic elements that are disposed partially or wholly in a PC, server, or other computing system capable of executing machine-readable instructions.

The processor-based device 600 includes a bus or similar communications link 616 that communicably couples and facilitates the exchange of information and/or data between various system components including the processor circuitry 610, the graphics processor circuitry 612, one or more wireless I/O interfaces 620, one or more wired I/O interfaces 630, the system memory 640, one or more network interfaces 670, and/or one or more storage devices 690. The processor-based device 600 may be referred to in the singular herein, but this is not intended to limit the embodiments to a single processor-based device 600, since in certain embodiments, there may be more than one processor-based device 600 that incorporates, includes, or contains any number of communicably coupled, collocated, or remote networked circuits or devices.

The system memory 640 may include read-only memory (“ROM”) 642 and random access memory (“RAM”) 646. A portion of the ROM 642 may be used to store or otherwise retain a basic input/output system (“BIOS”) 644. The BIOS 644 provides basic functionality to the processor-based device 600, for example by causing the processor circuitry 610 to load and/or execute one or more machine-readable instruction sets 614. In embodiments, at least some of the one or more machine-readable instruction sets 614 cause at least a portion of the processor circuitry 610 to provide, create, produce, transition, and/or function as a dedicated, specific, and particular machine, for example a word processing machine, a digital image acquisition machine, a media playing machine, a gaming system, a communications device, a smartphone, or similar.

The processor-based device 600 may include at least one wireless input/output (I/O) interface 620. The at least one wireless I/O interface 620 may be communicably coupled to one or more physical output devices 622 (tactile devices, video displays, audio output devices, hardcopy output devices, etc.). The at least one wireless I/O interface 620 may communicably couple to one or more physical input devices 624 (pointing devices, touchscreens, keyboards, tactile devices, etc.). The at least one wireless I/O interface 620 may include any currently available or future developed wireless I/O interface. Example wireless I/O interfaces include, but are not limited to: BLUETOOTH®, near field communication (NFC), and similar.

The processor-based device 600 may include one or more wired input/output (I/O) interfaces 630. The at least one wired I/O interface 630 may be communicably coupled to one or more physical output devices 622 (tactile devices, video displays, audio output devices, hardcopy output devices, etc.). The at least one wired I/O interface 630 may be communicably coupled to one or more physical input devices 624 (pointing devices, touchscreens, keyboards, tactile devices, etc.). The wired I/O interface 630 may include any currently available or future developed I/O interface. Example wired I/O interfaces include, but are not limited to: universal serial bus (USB), IEEE 1394 (“FireWire”), and similar.

The processor-based device 600 may include one or more communicably coupled, non-transitory, data storage devices 690. The data storage devices 690 may include one or more hard disk drives (HDDs) and/or one or more solid-state storage devices (SSDs). The one or more data storage devices 690 may include any current or future developed storage appliances, network storage devices, and/or systems. Non-limiting examples of such data storage devices 690 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 690 may include one or more removable storage devices, such as one or more flash drives, flash memories, flash storage units, or similar appliances or devices capable of communicable coupling to and decoupling from the processor-based device 600.

The one or more data storage devices 690 may include interfaces or controllers (not shown) communicatively coupling the respective storage device or system to the bus 616. The one or more data storage devices 690 may store, retain, or otherwise contain machine-readable instruction sets, data structures, program modules, data stores, databases, logical structures, and/or other data useful to the processor circuitry 610 and/or graphics processor circuitry 612 and/or one or more applications executed on or by the processor circuitry 610 and/or graphics processor circuitry 612. In some instances, one or more data storage devices 690 may be communicably coupled to the processor circuitry 610, for example via the bus 616 or via one or more wired communications interfaces 630 (e.g., Universal Serial Bus or USB); one or more wireless communications interfaces 620 (e.g., Bluetooth®, Near Field Communication or NFC); and/or one or more network interfaces 670 (IEEE 802.3 or Ethernet, IEEE 802.11, or WiFi®, etc.).

Machine-readable instruction sets 614 and other programs, applications, logic sets, and/or modules may be stored in whole or in part in the system memory 640. Such instruction sets 614 may be transferred, in whole or in part, from the one or more data storage devices 690. The instruction sets 614 may be loaded, stored, or otherwise retained in system memory 640, in whole or in part, during execution by the processor circuitry 610 and/or graphics processor circuitry 612.

The processor-based device 600 may include power management circuitry 650 that controls one or more operational aspects of the energy storage device 652. In embodiments, the energy storage device 652 may include one or more primary (i.e., non-rechargeable) or secondary (i.e., rechargeable) batteries or similar energy storage devices. In embodiments, the energy storage device 652 may include one or more supercapacitors or ultracapacitors. In embodiments, the power management circuitry 650 may alter, adjust, or control the flow of energy from an external power source 654 to the energy storage device 652 and/or to the processor-based device 600. The power source 654 may include, but is not limited to, a solar power system, a commercial electric grid, a portable generator, an external energy storage device, or any combination thereof.

For convenience, the processor circuitry 610, the graphics processor circuitry 612, the wireless I/0 interface 620, the wired I/0 interface 630, the system memory 640, the power management circuitry 650, the network interface 670, and the storage device 690 are illustrated as communicatively coupled to each other via the bus 616, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In another example, one or more of the above-described components may be integrated into the processor circuitry 610 and/or the graphics processor circuitry 612. In some embodiments, all or a portion of the bus 416 may be omitted and the components are coupled directly to each other using suitable wired or wireless connections.

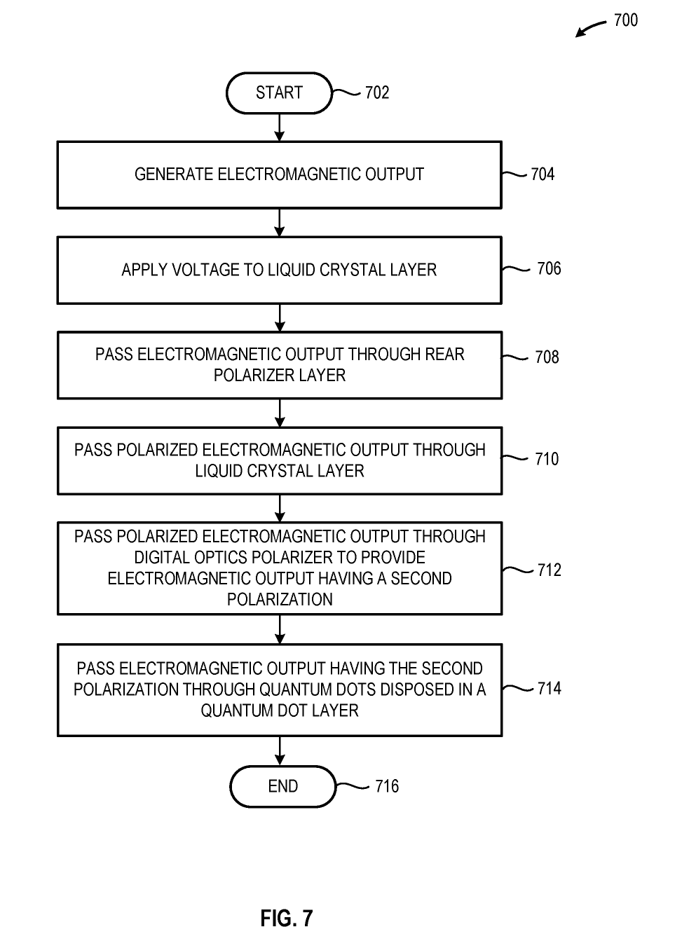

FIG. 7 is a high-level flow diagram of an illustrative method 700 of providing a display output using a quantum dot LCD display device that includes a digital optics polarizer 110 disposed between the LCD layer 120 and the quantum dot layer 130, in accordance with at least one embodiment described herein. The method commences at 702.

At 704, a backlight 210 generates an electromagnetic emission 140. In embodiments, the backlight 210 may include one or more blue light emitting diodes (LEDs) that provide an electromagnetic output in the visible blue electromagnetic spectrum. In other embodiments, the backlight 210 may include one or more ultraviolet light emitting diodes (LEDs) that provide an electromagnetic output in the ultraviolet spectrum. In embodiments, the backlight 210 may include a highly collimated light source.

At 706, voltage is applied to each of the liquid crystals 122 included in the LCD layer 120. The application of a voltage to the liquid crystals 122 alters or changes the transmissivity of the respective liquid crystal 122.

At 708, at least a portion of the electromagnetic emission 140 from the backlight 210 passes through a rear polarizer 220. The polarized electromagnetic energy 140P₁ exits from the front surface of the rear polarizer 220. The polarized electromagnetic energy 140P₁ exiting the rear polarizer may be linearly polarized, circularly polarized, or elliptically polarized.

At 710, the polarized electromagnetic energy 140P₁ enters the LCD layer 120 and passes through a liquid crystal 122 disposed in the LCD layer 120. The voltage applied to each liquid crystal (at 706) determines whether none, all, or just a portion of the polarized electromagnetic energy 140P₁ exits the LCD layer 120.

At 712, the polarized electromagnetic energy 140P₁ exiting the LCD layer 120 passes through the digital optics polarizer 110. The polarized electromagnetic energy 140P₂ exits from the front surface of the digital optics polarizer 110. The polarized electromagnetic energy 140P₂ exiting the rear polarizer may be linearly polarized, circularly polarized, or elliptically polarized.

At 714, the polarized electromagnetic energy 140P₂ exiting the digital optics polarizer 110 passes through the quantum dot layer 130 to produce an output in the visible electromagnetic spectrum. In some embodiments, where a blue LED backlight 210 is used, the quantum dot layer 130 may include only red quantum dots 132R and green quantum dots 132G and have optically transparent portions where the blue LED light exiting the LCD layer 120 is permitted to pass through the display surface. In some embodiments, the quantum dot layer 130 may include red quantum dots 132R, green quantum dots 132G, and blue quantum dots 132B. In embodiments, the quantum dot layer 130 may include pixelated quantum dots 132 that are disposed in a defined pattern. In other embodiments, the quantum dot layer 130 may include non-pixelated quantum dots 132 that are disposed randomly or pseudo-randomly across the quantum dot layer 130. The method 700 concludes at 716.

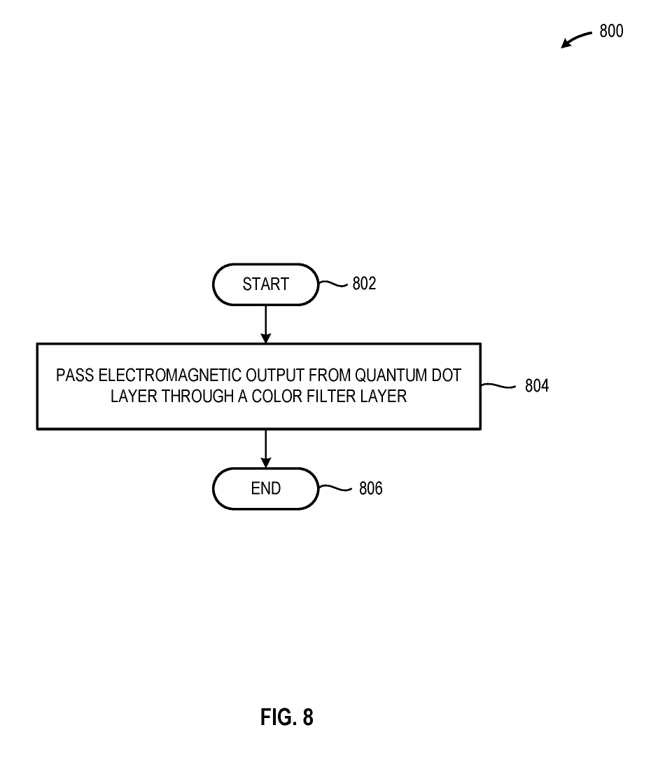

FIG. 8 is a high-level flow diagram of an illustrative method 800 of providing a display output using a quantum dot LCD display device that includes a digital optics polarizer 110 disposed between an LCD layer 120 and a quantum dot layer 130 and which includes a thin color filter 430 to improve the contrast and clarity of the display image, in accordance with at least one embodiment described herein. The method 800 may be used in conjunction with the method 700 described above in regard to FIG. 7. The method commences at 802.

At 804, a color filter 430 is positioned between the quantum dot layer 130 and the cover layer 230 of the LCD display device. In pixelated quantum dot LCD displays, the color filter 430 may improve contrast of the display image, particularly in bright ambient conditions. In non-pixelated quantum dot LCD displays, the color filter 430 converts the generally white light output provided by the non-pixelated quantum dot layer 130 into visible red, green, and blue electromagnetic emissions. The method 800 concludes at 806.

While FIGS. 7 and 8 illustrate various operations according to one or more embodiments, it is to be understood that not all of the operations depicted in FIGS. 7 and 8 are necessary for other embodiments. Indeed, it is fully contemplated herein that in other embodiments of the present disclosure, the operations depicted in FIGS. 7 and 8, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices.

As used in any embodiment herein, the term “circuitry” may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to quantum dot LCD display systems and methods that use a digital optics polarizer to beneficially and advantageously provide enhanced performance and substantially lower power draw. The digital optics polarizer is disposed as a metasurface between the LCD layer and the quantum dot layer within the LCD display device. The digital optics polarizer is formed using a dielectric material, such as TiO₂, that does not cause reflectivity and ohmic loss issues typically encountered with wire grid polarizers. The digital optics polarizer may be patterned, deposited, or otherwise disposed across all or a portion of the LCD layer, the quantum dot layer, or may be “sandwiched” between and proximate the LCD layer and the quantum dot layer. The elimination of ohmic losses in the digital optics polarizer significantly improves the energy efficiency of the LCD display.

The following examples pertain to further embodiments. The following examples of the present disclosure may comprise subject material such as at least one device, a method, means for performing acts based on the method and/or a system for providing a quantum dot LCD display device that includes a digital optics polarizer disposed as a metasurface between the LCD layer and the quantum dot layer within the LCD display device.

According to example 1, there is provided a liquid crystal display (LCD). The LCD may include: a quantum dot color converter; a liquid crystal layer; and a metasurface layer that provides a digital optics polarizer disposed between the quantum dot color converter and the liquid crystal layer.

Example 2 may include elements of example 1 where the metasurface layer comprises a layer that includes dielectric nanostructures having a thickness of less than 500 nm.

Example 3 may include elements of any of examples 1 or 2 where the metasurface layer comprises a dielectric material having a common phase profile across the liquid crystal display.

Example 4 may include elements of any of examples 1 through 3 where the phase profile of the metasurface layer passes at least a portion of incident linearly polarized light that exits the liquid crystal layer and absorbs at least a portion of incident perpendicularly polarized light that exits the liquid crystal layer.

Example 5 may include elements of any of examples 1 through 4 where the metasurface layer comprises a dielectric material having a pixelated phase profile across the liquid crystal display.

Example 6 may include elements of any of examples 1 through 5 where the pitch of each metasurface pixel included in the pixelated profile is randomly variable across the liquid crystal display.

Example 7 may include elements of any of examples 1 through 6 where the thickness of each metasurface pixel included in the pixelated profile is randomly variable across the liquid crystal display.

Example 8 may include elements of any of examples 1 through 7 where the phase profile of the metasurface layer passes at least a portion of incident linearly polarized light that exits the liquid crystal layer and absorbs at least a portion of incident perpendicularly polarized light that exits the liquid crystal layer.

Example 9 may include elements of any of examples 1 through 8 and the LCD may additionally include: a highly collimated light source that includes at least one of: a blue light source or an ultraviolet light source.

Example 10 may include elements of any of examples 1 through 9 where the quantum dot color converter provides two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 11 may include elements of any of examples 1 through 10 where the quantum dot color converter comprises a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 12 may include elements of any of examples 1 through 11, and the LCD may additionally include: a color filter layer disposed proximate the quantum dot color converter; wherein the color filter layer includes two or more of: a red color filter portion, a green color filter portion, or a blue color filter portion; wherein the quantum dot color converter comprises a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum; and wherein the red color filter portion is positioned proximate at least a portion of the red quantum dots and the green color filter portion is positioned proximate at least a portion of the red quantum dots.

Example 13 may include elements of any of examples 1 through 12 where the quantum dot color converter comprises a non-pixelated quantum dot layer having randomly distributed quantum dots that include two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 14 may include elements of any of examples 1 through 13, and the LCD may additionally include: a color filter layer disposed proximate the quantum dot color converter; and wherein the color filter layer includes two or more of: a red color filter portion, a green color filter portion, or a blue color filter portion.

According to example 15, there is provided a method of generating an image using a liquid crystal display (LCD). The method may include: generating an electromagnetic output; applying a current to a liquid crystal layer; causing at least a portion of the generated electromagnetic output to pass through a first polarizer to provide an electromagnetic output having a first polarization; causing at least a portion of the electromagnetic output having a first polarization to pass through the liquid crystal layer; causing at least a portion of the electromagnetic output exiting the liquid crystal layer to pass through a digital optics polarizer that includes metasurface layer to provide an electromagnetic output having a second polarization; and causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 16 may include elements of example 15 where generating an electromagnetic output may include: generating a highly collimated electromagnetic output that includes electromagnetic energy in at least a portion of at least one of: the visible blue spectrum or the ultraviolet spectrum.

Example 17 may include elements of any of examples 15 or 16 where causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum further may include: causing at least a portion of the electromagnetic output having a first polarization to pass through a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 18 may include elements of any of examples 15 through 17, and the method may additionally include: causing at least a portion of the electromagnetic output exiting the quantum dot color converter to pass through a color filter layer disposed proximate the quantum dot color converter; where the color filter layer includes two or more of: a red color filter portion, a green color filter portion, or a blue color filter portion; and where the red color filter portion is positioned proximate at least a portion of the red quantum dots and the green color filter portion is positioned proximate at least a portion of the red quantum dots.

Example 19 may include elements of any of examples 15 through 18 where causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum may further include: causing at least a portion of the electromagnetic output having a first polarization to pass through a non-pixelated quantum dot layer having randomly distributed quantum dots that include two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 20 may include elements of any of examples 15 through 19, and the method may additionally include: causing at least a portion of the electromagnetic output exiting the quantum dot color converter to pass through a color filter layer disposed proximate the quantum dot color converter; where the color filter layer includes two or more of: a red color filter portion, a green color filter portion, or a blue color filter portion.

According to example 21, there is provided a system for generating an image using a liquid crystal display (LCD). The system may include: means for generating an electromagnetic output; means for applying a current to a liquid crystal layer; means for causing at least a portion of the generated electromagnetic output to pass through a first polarizer to provide an electromagnetic output having a first polarization; means for causing at least a portion of the electromagnetic output having a first polarization to pass through the liquid crystal layer; means for causing at least a portion of the electromagnetic output exiting the liquid crystal layer to pass through a digital optics polarizer that includes metasurface layer to provide an electromagnetic output having a second polarization; and means for causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 22 may include elements of example 21 where the means for generating an electromagnetic output may include: means for generating a highly collimated electromagnetic output that includes electromagnetic energy in at least a portion of at least one of: the visible blue spectrum or the ultraviolet spectrum.

Example 23 may include elements of any of examples 21 or 22 where the means for causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum may include: means for causing at least a portion of the electromagnetic output having a first polarization to pass through a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 24 may include elements of any of examples 21 through 23, and the system may further include: means for causing at least a portion of the electromagnetic output exiting the quantum dot color converter to pass through a color filter layer disposed proximate the quantum dot color converter; where the color filter layer includes two or more of: a red color filter portion, a green color filter portion, or a blue color filter portion; and the red color filter portion is positioned proximate at least a portion of the red quantum dots and the green color filter portion is positioned proximate at least a portion of the red quantum dots.

Example 25 may include elements of any of examples 21 through 24 where the means for causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum may further include: means for causing at least a portion of the electromagnetic output having a first polarization to pass through a non-pixelated quantum dot layer having randomly distributed quantum dots that include two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 26 may include elements of any of examples 21 through 25, and the system may further include: means for causing at least a portion of the electromagnetic output exiting the quantum dot color converter to pass through a color filter layer disposed proximate the quantum dot color converter; where the color filter layer includes two or more of: a red color filter portion, a green color filter portion, or a blue color filter portion.

According to example 27, there is provided electronic device. The electronic device may include: processor circuitry; output interface circuitry; and a liquid crystal display coupled to the output interface circuitry, the liquid crystal display including: a quantum dot color converter; a liquid crystal layer; and a metasurface layer that provides a digital optics polarizer disposed between the quantum dot color converter and the liquid crystal layer.

Example 28 may include elements of example 27 where the metasurface layer comprises a layer that includes a dielectric material having a thickness of less than 500 nanometers (nm).

Example 29 may include elements of any of examples 27 or 28 where the metasurface layer comprises a dielectric material having a common phase profile across the liquid crystal display.

Example 30 may include elements of any of examples 27 through 29 where the phase profile of the metasurface layer passes at least a portion of incident linearly polarized light that exits the liquid crystal layer and absorbs at least a portion of incident perpendicularly polarized light that exits the liquid crystal layer.

Example 31 may include elements of any of examples 27 through 30 where the metasurface layer comprises a dielectric material having a pixelated phase profile across the liquid crystal display.

Example 32 may include elements of any of examples 27 through 31 where the pitch of each metasurface pixel included in the pixelated profile is randomly variable across the liquid crystal display.

Example 33 may include elements of any of examples 27 through 32 where the thickness of each metasurface pixel included in the pixelated profile is randomly variable across the liquid crystal display.

Example 34 may include elements of any of examples 27 through 33 where the phase profile of the metasurface layer passes at least a portion of incident linearly polarized light that exits the liquid crystal layer and absorbs at least a portion of incident perpendicularly polarized light that exits the liquid crystal layer.

Example 35 may include elements of any of examples 27 through 34, and the electronic device may additionally include: a highly collimated light source that includes at least one of: a blue light source or an ultraviolet light source.

Example 36 may include elements of any of examples 27 through 35 where the quantum dot color converter provides two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 37 may include elements of any of examples 27 through 36 where the quantum dot color converter comprises a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 38 may include elements of any of examples 27 through 37, and the electronic device may additionally include: a color filter layer disposed proximate the quantum dot color converter; where the color filter layer includes two or more of: a red color filter portion, a green color filter portion, or a blue color filter portion; where the quantum dot color converter comprises a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum; and where the red color filter portion is positioned proximate at least a portion of the red quantum dots and the green color filter portion is positioned proximate at least a portion of the red quantum dots.

Example 39 may include elements of any of examples 27 through 38 where the quantum dot color converter comprises a non-pixelated quantum dot layer having randomly distributed quantum dots that include two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

Example 40 may include elements of any of examples 27 through 39, and the electronic device may additionally include: a color filter layer disposed proximate the quantum dot color converter; and where the color filter layer includes two or more of: a red color filter portion, a green color filter portion, or a blue color filter portion.

According to example 41, there is provided a system for providing a liquid crystal display (LCD) that includes a digital optics polarizer, the system being arranged to perform the method of any of examples 15 through 20.

According to example 42, there is provided a chipset arranged to perform the method of any of examples 15 through 20.

According to example 43, there is provided at least one non-transitory machine readable medium comprising a plurality of instructions that, in response to be being executed on a processor-based device, cause the computing device to carry out the method according to any of examples 15 through 20.

According to example 44, there is provided a device configured for providing a liquid crystal display (LCD) that includes a digital optics polarizer, the device being arranged to perform the method of any of the examples 11 through 20.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed:

1. A liquid crystal display, comprising:
a quantum dot color converter;
a liquid crystal layer; and
a metasurface layer that provides a digital optics polarizer disposed between the quantum dot color converter and the liquid crystal layer.

2. The liquid crystal display of claim 1 wherein the metasurface layer comprises a layer that includes a dielectric material having a thickness of less than 500 nanometers (nm).

3. The liquid crystal display of claim 2 wherein the metasurface layer comprises a dielectric material having a common phase profile across the liquid crystal display.

4. The liquid crystal display of claim 3 wherein the phase profile of the metasurface layer passes at least a portion of incident linearly polarized light that exits the liquid crystal layer and absorbs at least a portion of incident perpendicularly polarized light that exits the liquid crystal layer.

5. The liquid crystal display of claim 2 wherein the metasurface layer comprises a dielectric material having a pixelated phase profile across the liquid crystal display.

6. The liquid crystal display of claim 5 wherein the pitch of each metasurface pixel included in the pixelated profile is randomly variable across the liquid crystal display.

7. The liquid crystal display of claim 5 wherein the thickness of each metasurface pixel included in the pixelated profile is randomly variable across the liquid crystal display.

8. The liquid crystal display of claim 5 wherein the phase profile of the metasurface layer passes at least a portion of incident linearly polarized light that exits the liquid crystal layer and absorbs at least a portion of incident perpendicularly polarized light that exits the liquid crystal layer.

9. The liquid crystal display of claim 1, further comprising:
a highly collimated light source that includes at least one of: a blue light source or an ultraviolet light source.

10. The liquid crystal display of claim 9 wherein the quantum dot color converter provides two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

11. The liquid crystal display of claim 1 wherein the quantum dot color converter comprises a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

12. The liquid crystal display of claim 1, further comprising:
a color filter layer disposed proximate the quantum dot color converter;
wherein the color filter layer includes two or more of: a red color filter portion, a green color filter portion, or a blue color filter portion;
wherein the quantum dot color converter comprises a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum; and
wherein the red color filter portion is positioned proximate at least a portion of the red quantum dots and the green color filter portion is positioned proximate at least a portion of the red quantum dots.

13. The liquid crystal display of claim 1 wherein the quantum dot color converter comprises a non-pixelated quantum dot layer having randomly distributed quantum dots that include two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

14. The liquid crystal display of claim 13, further comprising:
a color filter layer disposed proximate the quantum dot color converter; and
wherein the color filter layer includes two or more of: a red color filter portion, a green color filter portion, or a blue color filter portion.

15. A method of generating an image using a liquid crystal display, comprising:
generating an electromagnetic output;
applying a current to a liquid crystal layer;
causing at least a portion of the generated electromagnetic output to pass through a first polarizer to provide an electromagnetic output having a first polarization;
causing at least a portion of the electromagnetic output having a first polarization to pass through the liquid crystal layer;
causing at least a portion of the electromagnetic output exiting the liquid crystal layer to pass through a digital optics polarizer that includes metasurface layer to provide an electromagnetic output having a second polarization;
causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

16. The method of claim 15 wherein generating an electromagnetic output comprises:
generating a highly collimated electromagnetic output that includes electromagnetic energy in at least a portion of at least one of: the visible blue spectrum or the ultraviolet spectrum.

17. The method of claim 15 wherein causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum further comprises:
causing at least a portion of the electromagnetic output having a first polarization to pass through a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

18. The method of claim 17 further comprising:
causing at least a portion of the electromagnetic output exiting the quantum dot color converter to pass through a color filter layer disposed proximate the quantum dot color converter;
wherein the color filter layer includes two or more of: a red color filter portion, a green color filter portion, or a blue color filter portion; and
wherein the red color filter portion is positioned proximate at least a portion of the red quantum dots and the green color filter portion is positioned proximate at least a portion of the red quantum dots.

19. The method of claim 15 wherein causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum further comprises:
causing at least a portion of the electromagnetic output having a first polarization to pass through a non-pixelated quantum dot layer having randomly distributed quantum dots that include two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

20. The method of claim 19, further comprising:
causing at least a portion of the electromagnetic output exiting the quantum dot color converter to pass through a color filter layer disposed proximate the quantum dot color converter;
wherein the color filter layer includes two or more of: a red color filter portion, a green color filter portion, or a blue color filter portion.

21. A system of generating an image using a liquid crystal display, comprising:
means for generating an electromagnetic output;
means for applying a current to a liquid crystal layer;
means for causing at least a portion of the generated electromagnetic output to pass through a first polarizer to provide an electromagnetic output having a first polarization;
means for causing at least a portion of the electromagnetic output having a first polarization to pass through the liquid crystal layer;
means for causing at least a portion of the electromagnetic output exiting the liquid crystal layer to pass through a digital optics polarizer that includes metasurface layer to provide an electromagnetic output having a second polarization;
means for causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

22. The system of claim 21 wherein the means for generating an electromagnetic output comprises:
means for generating a highly collimated electromagnetic output that includes electromagnetic energy in at least a portion of at least one of: the visible blue spectrum or the ultraviolet spectrum.

23. The system of claim 21 wherein the means for causing at least a portion of the electromagnetic output having a first polarization to pass through a quantum dot color converter that includes at least two of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum further comprises:
means for causing at least a portion of the electromagnetic output having a first polarization to pass through a single, pixelated, quantum dot layer that includes two or more of: red quantum dots that provide an electromagnetic emission in at least a portion of a visible red spectrum; green quantum dots that provide an electromagnetic emission in at least a portion of a visible green spectrum; or blue quantum dots that provide an electromagnetic emission in at least a portion of a visible blue spectrum.

24. The system of claim 23 further comprising:
means for causing at least a portion of the electromagnetic output exiting the quantum dot color converter to pass through a color filter layer disposed proximate the quantum dot color converter;
wherein the color filter layer includes two or more of: a red color filter portion, a green color filter portion, or a blue color filter portion; and
wherein the red color filter portion is positioned proximate at least a portion of the red quantum dots and the green color filter portion is positioned proximate at least a portion of the red quantum dots.

25. An electronic device, comprising:
processor circuitry;
output interface circuitry; and
a liquid crystal display coupled to the output interface circuitry, the liquid crystal display including:
a quantum dot color converter;
a liquid crystal layer; and
a metasurface layer that provides a digital optics polarizer disposed between the quantum dot color converter and the liquid crystal layer.
